(19) United States
(12) Patent Application Publication
(10) Pub. No.: US 2024/0409713 A1
(43) Pub. Date: Dec. 12, 2024

(54) POLYURETHANE COMPOSITIONS, POLYURETHANE FOAMS HAVING REDUCED ODOR PREPARED WITH SAME AND PREPARATION METHODS THEREOF

(71) Applicant: Dow Global Technologies LLC, Midland, MI (US)

(72) Inventors: Zhengming Tang, Shanghai (CN); Jian Zou, Shanghai (CN); Haiying Li, Shanghai (CN); Ryota Iwasaki, Yokohama (JP); Joey W. Storer, Midland, MI (US); Jie Ji, Shanghai (CN); Shuyu Duan, Shanghai (CN); Canzheng Cai, Shanghai (CN); Shaoguang Feng, Shanghai (CN); Ping Zhang, Shanghai (CN)

(21) Appl. No.: 18/702,094

(22) PCT Filed: Oct. 29, 2021
(86) PCT No.: PCT/CN2021/127256

§ 371 Date: Apr. 17, 2024

(51) Int. Cl. C08K 5/103; C08G 18/18; C08G 18/32; C08G 18/48; C08G 18/66; C08G 18/76

(52) U.S. Cl. CPC C08K 5/103; C08G 18/1808; C08G 18/1825; C08G 18/3275; C08G 18/4833; C08G 18/6688; C08G 18/7671; C08G 2110/0083

(57) ABSTRACT

A polyurethane composition, comprising (A) an isocyanate compound; (B) a polyol compound; and (C) an amine-based catalyst system comprising (C1) at least one amine-based catalyst and (C2) at least one deodorant represented by Formula (1) or Formula (2), is provided. The polyurethane foam prepared by using said polyurethane composition exhibits extremely low odor intensity and superior performance properties, e.g. foaming degree and mechanical strength. A method for preparing a polyurethane foam with reduced odor is also provided.

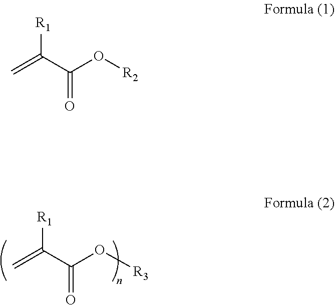

### FIELD OF THE INVENTION

The present disclosure relates to a polyurethane (PU) composition, a polyurethane foam having reduced odor prepared by using the composition and a method for preparing the polyurethane foam having reduced odor. The polyurethane composition exhibits high odor elimination effect while retaining good foaming or frothing reactivity, and the polyurethane foam prepared with the polyurethane composition exhibits extremely low odor intensity and superior mechanical strength.

### BACKGROUND TECHNOLOGY

Polyurethane foam have been widely used in various office, household and vehicular applications such as Noise, Vibration and Harshness (NVH), seating materials for house furnishings, bedding and automotive industries, thermal insulation, shoemaking (e.g., soles), and the like. A long-lasting disadvantage of the polyurethane foam is the unpleasant and pungent odor which is essentially caused by the emission of small molecular amines, e.g. dimethylamine (DMA), trimethylamine (TMA) and the like, which are derived from the amine-type substance for catalyzing the reaction between the isocyanate and polyol raw materials. Due to the increasingly stricter environmental regulations all around the world and frequent complaint from customers, immense and concrete researches have been conducted to develop a polyurethane foam which exhibits reduced odor or can even be basically odorless. Nevertheless, there are still a plurality of challenges to be overcome. For example, one of the challenges is the extremely low threshold of the odor derived from DMA and TMA, and the amounts thereof have to be reduced to a very low level, such as less than 0.047 ppm for DMA, and less than 0.00021 ppm for TMA, so as to completely eliminate the fishy odor by e.g. chemically modifying the molecular structure of the catalyst or selecting alternative catalyst. The above said chemical modification is also challenging since it may bring about additional negative influence on the performance properties of the polyurethane composition or the resultant polyurethane foam, such as insufficient foaming reactivity or deteriorated mechanical strengths.

For the above reasons, there is still a need in the polyurethane foam manufacturing industry to develop a polyurethane composition having effectively eliminated odor, superior foaming reactivity and mechanical properties with an economical way. After persistent exploration, the inventors have surprisingly developed a polyurethane composition which can achieve the above targets.

### SUMMARY OF THE INVENTION

The present disclosure provides a unique polyurethane composition, a polyurethane foam article or product prepared by using the composition, a method for preparing a polyurethane foam product and a method for reducing the odor of the polyurethane foam product.

In a first aspect of the present disclosure, the present disclosure provides a polyurethane composition for preparing a polyurethane foam with reduced odor, wherein the polyurethane composition comprises:
(A) at least one isocyanate compound comprising at least two isocyanate groups;
(B) at least one polyol compound; and
(C) an amine-based catalyst system, comprising
(C1) at least one amine-based catalyst selected from the group consisting of aliphatic diamine, aliphatic triamine, cycloaliphatic monoamine, cycloaliphatic diamine, cycloaliphatic triamine, araliphatic monoamine, araliphatic diamine, araliphatic triamine, aromatic monoamine, aromatic diamine, aromatic triamines, heterocyclic monoamine, heterocyclic diamine, heterocyclic triamine, and any combinations thereof; and
(C2) at least one deodorant represented by Formula (1) or Formula (2)

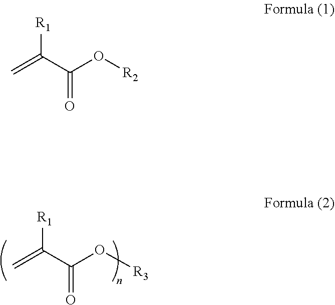

wherein R₁ is hydrogen or methyl, R₂ is selected from the group consisting of C₁-C₁₂ alkyl, hydroxy-substituted C₁-C₁₂ alkyl, and (meth)acryloxy(C₁-C₁₂alkylene)-O-(C₁-C₁₂) alkyl, and R₃ is selected from the group consisting of divalent C₂-C₁₂ alkylene, trivalent C₃-C₁₂ alkylene and tetravalent C₄-C₁₂ alkylene, n is an integer of 2 to 4.

In a second aspect of the present disclosure, the present disclosure provides a polyurethane foam article prepared with the polyurethane composition of the present disclosure, wherein the polyurethane foam article has reduced odor.

In a third aspect of the present disclosure, the present disclosure provides a method of producing a polyurethane foam with reduced odor, wherein the method comprises the steps of:
(i) combining at least one amine-based catalyst with at least one deodorant to form an amine-based catalyst system;
(ii) reacting at least one isocyanate compound comprising at least two isocyanate groups with at least one polyol compound in the presence of the amine-based catalyst system to produce the polyurethane foam with reduced odor;
wherein the amine-based catalyst is selected from the group consisting of aliphatic diamine, aliphatic triamine, cycloaliphatic monoamine, cycloaliphatic diamine, cycloaliphatic triamine, araliphatic monoamine, araliphatic diamine, araliphatic triamine, aromatic monoamine, aromatic diamine, aromatic triamines, heterocyclic monoamine, heterocyclic diamine, heterocyclic triamine, and any combinations thereof; and
the deodorant has a molecular structure represented by Formula (1) or Formula (2)

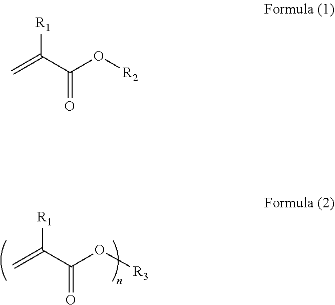

wherein R₁ is hydrogen or methyl, R₂ is selected from the group consisting of C₁-C₁₂ alkyl, hydroxy-substituted C₁-C₁₂ alkyl, and (meth)acryloxy(C₁-C₁₂ alkylene)-O—(C₁-C₁₂) alkyl, and R₃ is selected from the group consisting of divalent C₂-C₁₂ alkylene, trivalent C₃-C₁₂ alkylene and tetravalent C₄-C₁₂ alkylene, n is an integer of 2 to 4.

In a fourth aspect of the present disclosure, the present disclosure provides a method of reducing the odor of a polyurethane foam, wherein the method comprises the steps of:
(i) combining at least one amine-based catalyst with at least one deodorant to form an amine-based catalyst system;
(ii) catalyzing the reaction between isocyanate compound comprising at least two isocyanate groups and polyol compound with the amine-based catalyst system, to produce a polyurethane foam with reduced odor;
wherein the amine-based catalyst and the deodorant refer to those as stated above.

In a fifth aspect of the present disclosure, the present disclosure provides a method of reducing the odor of a catalyst system for preparing polyurethane foam, wherein the method comprises the steps of combining at least one amine-based catalyst as stated above with at least one deodorant as stated above to form an amine-based catalyst system for preparing polyurethane foam.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. Unless indicated otherwise, all the percentages and ratios are calculated based on weight, and all the molecular weights are number average molecular weights.

Without being limited to any specific theory, the technical breakthrough of the present disclosure mainly resides in the particularly designed formulation of the amine-based catalyst system for preparing polyurethane foam. Especially, it is found that an amine-based catalyst system obtained by combining a deodorant represented by Formula (1) or Formula (2) with particularly selected amine-based catalyst exhibit a substantially reduced or diminished concentration of odor-generating substances, particularly DMA and/or TMA, and the PU foam prepared by using said amine-based catalyst system can successfully achieve a desirable combination of performance properties including reduced odor, good foaming degree and superior mechanical strengths.

In the context of the present disclosure, the terms “polyurethane foam with reduced odor” and “polyurethane foam having reduced odor” are used interchangeably and refer to a polyurethane foam which will emit reduced amount, significantly reduced amount, or even inappreciable amount of DMA and/or TMA to the surrounding environment. For example, it is reported that the odor thresholds of DMA and TMA in air are 0.047 ppm and 0.00021 ppm, respectively, thus the concentration of DMA and/or TMA emitted from the polyurethane foam with reduced odor to the air can be close to or low than said thresholds. Besides, the “polyurethane foam with reduced odor” will exhibit a DMA and/or TMA emission reduction of 35 wt % to 100 wt % for DMA and 40-99 wt % (e.g. 50-65 wt %) for TMA.

According to an embodiment of the present disclosure, the amine-based catalyst system comprises at least one amine-based catalyst and at least one deodorant represented by Formula (1) or Formula (2), and may optionally comprise one or more other components, such as a catalyst other than the amine-based catalyst, co-catalyst, promoter, inhibiter, solvent, co-solvent, diluent, pH adjusting agent, buffering agent, and any combinations thereof. For example, the catalyst other than the amine-based catalyst may include glycine salts; tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt; or mixtures thereof. According to one embodiment of the present disclosure, the amine-based catalyst system exclusively comprises said amine-based catalyst and does not comprise other catalysts. According to another embodiment of the present disclosure, the amine-based catalyst system consists of at least one amine-based catalyst and at least one deodorant represented by Formula (1) or Formula (2), and does not comprise any other components, such as those stated above. According to an embodiment of the present disclosure, the weight ratio between the deodorant and the amine-based catalyst is from 0.5:100 to 15:100, or from 1:100 to 10:100, or from 1:100 to 5:100, such as within a numerical range obtained by combining any two of the following ratio values: 0.5:100, 0.8:100, 1:100, 1.2:100, 1.4:100, 1.5:100, 1.8:100, 2:100, 2.2:100, 2.5:100, 2.8:100, 3:100, 3.2:100, 3.5:100, 3.8:100, 4:100, 4.2:100, 4.5:100, 4.8:100, 5:100, 5.2:100, 5.5:100, 5.8:100, 6:100, 6.2:100, 6.5:100, 6.8:100, 7:100, 7.2:100, 7.5:100, 7.8:100, 8:100, 8.2:100, 8.5:100, 8.8:100, 9:100, 9.2:100, 9.5:100, 9.8:100, 10:100, 10.2:100, 10.5:100, 10.8:100, 11:100, 11.2:100, 11.5:100, 11.8:100, 12:100, 12.2:100, 12.5:100, 12.8:100, 13:100, 13.2:100, 13.5:100, 13.8:100, 14:100, 14.2:100, 14.5:100, 14.8:100 and 15:100.

As used therein, the term “amine-based catalyst” refers to at least one amine-type catalyst which may accelerate the reaction of the isocyanate groups in the isocyanate compound with the hydroxy groups and any other isocyanate-reactive groups in the polyol compound. According to an embodiment of the present disclosure, the amine-based catalyst is selected from the group consisting of aliphatic diamine, aliphatic triamine, cycloaliphatic monoamine, cycloaliphatic diamine, cycloaliphatic triamine, araliphatic monoamine, araliphatic diamine, araliphatic triamine, aromatic monoamine, aromatic diamine, aromatic triamines, heterocyclic monoamine, heterocyclic diamine, heterocyclic triamine, and any combinations thereof. Exemplary amine-based catalyst can be selected from the group consisting of ethylene diamine, propylene diamine, butylene diamine, pentylene diamine, neopentylenediamine, hexylene diamine, heptylene diamine, neoheptylene diamine, N,N-dimethylcyclohexylamine, bis(2-dimethylaminoethyl) ether, methyltriethylenediamine, dimethylaminopropylamine, bis(N,N-dimethyl-3-amino-propyl)amine, bis(2-dimethylamino ethyl)ether, 1,1′-((3-(di-methylamino)propyl)azanediyl) bis(propan-2-ol), 2,4,6-tridimethyl amino-methyl)phenol, N,N,N′,N′-tetra-methyl-ethylenediamine, N,N,N′,N′-tetramethyl-propylenediamine, N,N,N′,N′-tetramethyl-butylenediamine, N,N,N′,N′-tetramethyl-pentylene diamine, N,N,N′,N′-tetramethyl-hexylene diamine, N,N-dimethyl benzylamine, triethylene diamine, pentamethyldiethylenetriamine, diethylenetriamine, N-methylmorpholine, N-ethyl morpholine, 2-methylpropanediamine, N,N′-diethylpiperazine, N,N′-dimethyl piperazine, pyridine, N,N′-dimethyl pyridine, quinoline, N,N′,N″-tris(dimethyl amino-propyl)sym-hexahydro triazine, and any combinations thereof.

According to another embodiment of the present application, the amine-based catalyst may have a molecular structure represented by Formula (3):

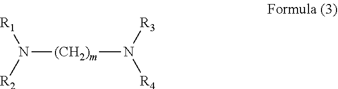

wherein m is an integer of 2 to 12, e.g. 2, 3, 4, 5, 6, 7, 8, 9, 10, 11 or 12; each of R₃ to R₆ is independently selected from the group consisting of H, C₁-C₁₂ alkyl, hydroxy-substituted C₁-C₁₂ alkyl, amino-substituted C₁-C₁₂ alkyl and amine-substituted C₁-C₁₂ alkyl. For example, each of R₃ to R₆ can be independently selected from the group consisting of hydrogen, methyl, ethyl, propyl, butyl, pentyl, hexyl, methylol, 1-hydroxy-ethyl, 2-hydroxy-ethyl, 1-hydroxy-propyl, 2-hydroxy-propyl, 3-hydroxy-propyl, 1-methyl-2-hydroxy-ethyl, hydroxybutyl, hydroxypentyl, hydroxyhexyl, 1-amino-ethyl, 2-amino-ethyl, 1-amino-propyl, 2-amino-propyl, 3-amino-propyl, 1-methyl-2-amino-ethyl, aminobutyl, aminopentyl, aminohexyl, N,N-dimethyl-amino-ethyl, N,N-dimethyl-amino-propyl, N,N-dimethyl-aminobutyl, N,N-dimethyl-aminopentyl, N,N-dimethyl-aminohexyl, and any isomeric forms thereof. According to another embodiment of the present application, the amine-based catalyst can be selected from the group consisting of N,N-dimethylcyclohexylamine, bis(2-dimethylamino ethyl) ether, dimethylaminopropylamine, bis(N,N-dimethyl-3-amino-propyl)amine, 1,1′-((3-(di-methyl amino)propyl)azanediyl)bis(propan-2-ol), and any combinations thereof.

According to an embodiment of the present disclosure, the amine-based catalyst particularly excludes small molecule aliphatic monoamine, especially, trimethylamine and dimethylamine, intentionally incorporated therein. For example, the amine-based catalyst of the present disclosure does not include pure or essentially pure aliphatic monoamine, e.g. methylamine, dimethylamine (DMA), trimethylamine (TMA), nor does the amine-based catalyst include said aliphatic monoamine intentionally incorporated therein.

Without being limited to any specific theory, it is believed that small or trace amount of DMA and TMA may inevitably exist in various commercially manufactured and purchased amine-type catalyst, such as those listed above, and can be derived from different sources including impurities in the raw materials, residual reactants and byproducts of the preparation process, as well as isomerization product, degradation product and incidental contamination ingredient introduced therein during the storage and transportation of the commercialized amine-type catalyst. The contents of the undesirable DMA and TMA in the amine-type catalyst may vary based on the specific category and source of the amine-type catalyst. According to one embodiment of the present application, the amine-type catalyst may have a DMA content of up to 1 wt %, or up to 0.1 wt %, or from 0.1 ppm to 0.01 wt %, based on the weight of the amine-type catalyst, or within a numerical range obtained by combining any two of the following end point values: 0.047 ppm, 0.05 ppm, 0.08 ppm, 0.1 ppm, 0.2 ppm, 0.3 ppm, 0.4 ppm, 0.5 ppm, 0.6 ppm, 0.7 ppm, 0.8 ppm, 0.9 ppm, 1 ppm, 3 ppm, 5 ppm, 10 ppm, 20 ppm, 50 ppm, 80 ppm, 100 ppm, 120 ppm, 150 ppm, 180 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm, 950 ppm, 1000 ppm, 1050 ppm, 1100 ppm, 1150 ppm, 1200 ppm, 1250 ppm, 1300 ppm, 1400 ppm, 1500 ppm, 1550 ppm, 1600 ppm, 1700 ppm, 1800 ppm, 1900 ppm, 2000 ppm, 2200 ppm, 2500 ppm, 2700 ppm, 2800 ppm, 2900 ppm, 3000 ppm, 3500 ppm, 3800 ppm, 4000 ppm, 4500 ppm, 4800 ppm, 5000 ppm, 5500 ppm, 6000 ppm, 6500 ppm, 7000 ppm, 7500 ppm, 8000 ppm, 8500 ppm, 9000 ppm, 9500 ppm and 1 wt %, based on the weight of the amine-type catalyst. According to another embodiment of the present application, the amine-type catalyst may have a TMA content of up to 1 wt %, or up to 0.1 wt %, or from 0.01 ppm to 0.01 wt %, based on the weight of the amine-type catalyst, or within a numerical range obtained by combining any two of the following end point values: 0.00021 ppm, 0.00025 ppm, 0.0003 ppm, 0.0004 ppm, 0.0005 ppm, 0.0006 ppm, 0.0008 ppm, 0.0009 ppm, 0.001 ppm, 0.0015 ppm, 0.002 ppm, 0.003 ppm, 0.004 ppm, 0.005 ppm, 0.006 ppm, 0.008 ppm, 0.01 ppm, 0.02 ppm, 0.03 ppm, 0.04 ppm, 0.05 ppm, 0.08 ppm, 0.1 ppm, 0.2 ppm, 0.3 ppm, 0.4 ppm, 0.5 ppm, 0.6 ppm, 0.7 ppm, 0.8 ppm, 0.9 ppm, 1 ppm, 3 ppm, 5 ppm, 10 ppm, 20 ppm, 50 ppm, 80 ppm, 100 ppm, 120 ppm, 150 ppm, 180 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm, 950 ppm, 1000 ppm, 1050 ppm, 1100 ppm, 1150 ppm, 1200 ppm, 1250 ppm, 1300 ppm, 1400 ppm, 1500 ppm, 1550 ppm, 1600 ppm, 1700 ppm, 1800 ppm, 1900 ppm, 2000 ppm, 2200 ppm, 2500 ppm, 2700 ppm, 2800 ppm, 2900 ppm, 3000 ppm, 3500 ppm, 3800 ppm, 4000 ppm, 4500 ppm, 4800 ppm, 5000 ppm, 5500 ppm, 6000 ppm, 6500 ppm, 7000 ppm, 7500 ppm, 8000 ppm, 8500 ppm, 9000 ppm, 9500 ppm and 1 wt %, based on the weight of the amine-type catalyst. According to one embodiment of the present application, the amine-type catalyst comprises DMA at above said amount as undesired impurities, and does not comprise TMA. According to another embodiment of the present application, the amine-type catalyst comprises TMA at above said amount as undesired impurities, and does not comprise DMA. According to another embodiment of the present application, the amine-type catalyst comprises both TMA and DMA at above said amounts as undesired impurities.

According to an embodiment of the present disclosure, the deodorant for reducing DMA and TMA in the amine-based catalyst has a molecular structure represented by Formula (1) or Formula (2)

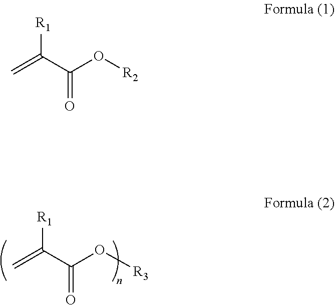

wherein R₁ is hydrogen or methyl, R₂ is selected from the group consisting of C₁-C₁₂ alkyl, hydroxy-substituted C₁-C₁₂ alkyl, and (meth)acryloxy(C₁-C₁₂ alkylene)-O—(C₁-C₁₂) alkyl, and R₃ is selected from the group consisting of divalent C₂-C₁₂ alkylene, trivalent C₃-C₁₂ alkylene and tetravalent C₄-C₁₂ alkylene, n is an integer of 2 to 4. According to one embodiment of the present disclosure, R₁ is hydrogen, R₂ is selected from the group consisting of C₁-C₁₂ alkyl, hydroxy-substituted C₁-C₁₂ alkyl and acryloxy(C₁-C₁₂ alkylene)-O—(C₁-C₁₂) alkyl, wherein the hydroxy group in the hydroxy-substituted C₁-C₁₂ alkyl is preferably attached to the terminal carbon atom of the alkyl group, and R₃ is selected from the group consisting of divalent C₂-C₁₂ alkylene, trivalent C₃-C₁₂ alkylene and tetravalent C₄-C₁₂ alkylene, n is an integer of 2 to 4. According to another embodiment of the present disclosure, the deodorant is selected from the group consisting of ethyl acrylate, propyl acrylate, butyl acrylate, pentyl acrylate, hexyl acrylate, 2-hydroxyethyl acrylate, 3-hydroxypropyl acrylate, 4-hydroxybutyl acrylate, 5-hydroxypentyl acrylate, 6-hydroxyhexyl acrylate, glycidyl diacrylate, ethylene diol diacrylate, propylene diol diacrylate, butylene diol diarcylate, hexane diol diacrylate, glycerol triacrylate, erythritol tetra(acrylate), pentaerythritol tetra(acrylate) and any combinations thereof.

According to one embodiment of the present application, the deodorant of Formula (1) or Formula (2) is combined with the amine-type catalyst so as to form an amine-based catalyst system having DMA and TMA contents reduced to lower levels determined by the related environmental regulations or the requirements of consumers, and the polyurethane foam article produced with said amine-based catalyst system has DMA and TMA amounts lower than the odor threshold perceptible to consumer. According to an embodiment of the present disclosure, the amine-based catalyst system may be formed by blending the deodorant of Formula (1) or Formula (2) with the amine-type catalyst, and then keeping the blend standing or under stirring at a temperature of 0 to 200° C. and a pressure of 0.01 to 10 MPa for 0.5 to 100 hours. The above stated temperature can be from 5 to 180° C., or from 10 to 150° C., or from 15 to 120° C., or from 20 to 100° C., or from 25 to 80° C., or from 25 to 50° C. The above stated pressure can be from 0.02 to 8 Mpa, or from 0.04 to 7 Mpa, or from 0.05 to 5 Mpa, or from 0.06 to 4 Mpa, or from 0.08 to 2 Mpa, or from 0.09 to 1 Mpa, or from 0.1 to 0.5 Mpa. The above stated duration for keeping the blend can be from 0.5 to 100 hour, or from 1 to 90 hour, or from 2 to 80 hour, or from 5 to 70 hour, or from 6 to 60 hour, or from 8 to 48 hour, or from 10 to 24 hour. According to one embodiment of the present disclosure, the blend of the deodorant of Formula (1) and the amine-type catalyst is kept standing at ambient temperature and pressure over night.

Without being limited to any theory, the amine-based catalyst system thus formed exhibits a DMA level of up to 100 ppm, or up to 80 ppm, or up to 70 ppm, or up to 60 ppm, or up to 50 ppm, or up to 40 ppm, or up to 30 ppm, or up to 20 ppm, or up to 19 ppm, or up to 16 ppm, or up to 15 ppm, or up to 13 ppm, or up to 12 ppm, or up to 10 ppm, or up to 8 ppm, or up to 6 ppm, or up to 5 ppm, or up to 3 ppm, or up to 1 ppm, or up to 0.5 ppm, or up to 0.2 ppm, or up to 0.1 ppm, or up to 0.05 ppm, or up to 0.01 ppm, based on the total weight of the amine-based catalyst system. According to another embodiment of the present disclosure, the polyurethane foam, polyurethane foam article or polyurethane foam product prepared by using the amine-based catalyst system exhibits a DMA level of up to 80 ppm, or up to 70 ppm, or up to 60 ppm, or up to 50 ppm, or up to 40 ppm, or up to 30 ppm, or up to 20 ppm, or up to 19 ppm, or up to 16 ppm, or up to 15 ppm, or up to 13 ppm, or up to 12 ppm, or up to 10 ppm, or up to 8 ppm, or up to 6 ppm, or up to 5 ppm, or up to 3 ppm, or up to 1 ppm, or up to 0.5 ppm, or up to 0.2 ppm, or up to 0.1 ppm, or up to 0.05 ppm, or up to 0.01 ppm, or up to 0.005 ppm, or up to 0.001 ppm, based on the total weight of the polyurethane foam. For example, due to the addition of deodorant represented by Formula (1), the DMA content in the amine-based catalyst system or the polyurethane foam may be reduced by 35 wt %, or by 40 wt %, or by 45 wt %, or by 50 wt %, or by 55 wt %, or by 60 wt %, or by 65 wt %, or by 70 wt %, or by 75 wt %, or by 80 wt %, or by 85 wt %, or by 90 wt %, or by 95 wt %, or by 98 wt %, or by 99 wt %, or by 99.5 wt %, or by 99.9 wt %, or by 99.95 wt %, or by 99.99 wt %, or even 100 wt %, as compared with the initial amount of DMA contained in the amine-type catalyst. According to another embodiment of the present disclosure, the amine-based catalyst system thus formed exhibits a TMA level of up to 100 ppm, or up to 80 ppm, or up to 70 ppm, or up to 60 ppm, or up to 50 ppm, or up to 40 ppm, or up to 30 ppm, or up to 20 ppm, or up to 19 ppm, or up to 16 ppm, or up to 15 ppm, or up to 13 ppm, or up to 12 ppm, or up to 10 ppm, or up to 8 ppm, or up to 6 ppm, or up to 5 ppm, or up to 3 ppm, or up to 1 ppm, or up to 0.5 ppm, or up to 0.2 ppm, or up to 0.1 ppm, or up to 0.05 ppm, or up to 0.01 ppm, based on the total weight of the amine-based catalyst system. According to another embodiment of the present disclosure, the polyurethane foam, polyurethane foam article or polyurethane foam product prepared by using the amine-based catalyst system exhibits a TMA level of up to 70 ppm, or up to 60 ppm, or up to 50 ppm, or up to 40 ppm, or up to 30 ppm, or up to 20 ppm, or up to 19 ppm, or up to 16 ppm, or up to 15 ppm, or up to 13 ppm, or up to 12 ppm, or up to 10 ppm, or up to 8 ppm, or up to 6 ppm, or up to 5 ppm, or up to 3 ppm, or up to 1 ppm, or up to 0.5 ppm, or up to 0.2 ppm, or up to 0.1 ppm, or up to 0.05 ppm, or up to 0.01 ppm, or up to 0.005 ppm, or up to 0.001 ppm, based on the total weight of the polyurethane foam. For example, due to the addition of deodorant represented by Formula (1), the TMA content in the amine-based catalyst system or the polyurethane foam may be reduced by 40 wt %, or by 45 wt %, or by 50 wt %, or by 55 wt %, or by 60 wt %, or by 65 wt %, or by 70 wt %, or by 75 wt %, or by 80 wt %, or by 85 wt %, or by 90 wt %, or by 95 wt %, or by 98 wt %, or by 99 wt %, as compared with the initial amount of TMA contained in the amine-type catalyst. According to one embodiment of the present disclosure, the content of the amine-based catalyst system can be from 0.01 wt % to 5 wt %, such as from 0.05 wt % to 4 wt %, or from 0.08 wt % to 3.5 wt %, or from 0.1 wt % to 3 wt %, or from 0.5 wt % to 2.5 wt %, or from 0.8 wt % to 2 wt %, or from 0.85 wt % to 1.5 wt %, or from 0.9 wt % to 1.2 wt %, or from 0.92 wt % to 1.0 wt %, based on the total weight of the polyurethane composition.

In various embodiments, the isocyanate compound having at least two isocyanate groups is also known as polyisocyanate compound and refers to an aliphatic, cycloaliphatic, aromatic, araliphatic or heteroaryl compound having at least two isocyanate groups. The isocyanate compound may have an average functionality of at least about 2.0, such as from about 2 to 10, or from about 2 to about 8, or from about 2 to about 6. Exemplary isocyanate compound can be selected from the group consisting of C₂-C₁₂ aliphatic isocyanate compound comprising at least two isocyanate groups, C₆-C₁₅ cycloaliphatic isocyanate compound comprising at least two isocyanate groups, C₆-C₁₅ aromatic isocyanate compound comprising at least two isocyanate groups, C₇-C₁₅ araliphatic isocyanate compound comprising at least two isocyanate groups, and any combinations thereof. In another embodiment, the isocyanate compounds may particularly include m-phenylene diisocyanate, 2,4-toluene diisocyanate and/or 2,6-toluene diisocyanate (TDI), various isomers of diphenylmethanediisocyanate (MDI), methylenebis(cyclohexyl isocyanate) (HMDI), hexamethylene-1,6-diisocyanate (HDI), tetramethylene-1,4-diisocyanate, cyclohexane-1,4-diisocyanate, hexahydrotoluene diisocyanate, hydrogenated MDI, naphthylene-1,5-diisocyanate, isophorone diisocyanate (IPDI), or mixtures thereof.

According to another embodiment of the present disclosure, the isocyanate compound can be modified isocyanate compounds, that is, products which are obtained through chemical modification of the above isocyanate compounds. Exemplary modified isocyanate compounds are polyisocyanates containing esters, ureas, biurets, isocyanurates, allophanates, carbodiimides or uretoneimines, such as 4,4′-carbodiimide modified MDI products. For example, liquid isocyanate compounds containing carbodiimide groups, uretoneimines groups or isocyanurate rings and having isocyanate group (NCO) contents of from 10 to 40 weight percent, such as from 20 to 35 weight percent, can be used.

Alternatively or additionally, the isocyanate compound may comprise an isocyanate prepolymer with a NCO functionality in the range of 2 to 10, such as from 2 to 8, or from 2 to 6. The isocyanate prepolymer can be obtained by reacting one or more of the above stated monomeric isocyanate compound(s) with one or more isocyanate-reactive compounds selected from the group consisting of C₂-C₁₆ aliphatic polyhydric alcohol comprising at least two hydroxy groups, C₅-C₁₆ cycloaliphatic polyhydric alcohol comprising at least two hydroxy groups, C₆-C₁₆ aromatic polyhydric alcohol comprising at least two hydroxy groups, C₇-C₁₅ araliphatic polyhydric alcohol comprising at least two hydroxy groups, polyester polyol having a molecular weight from 500 to 5,000, polycarbonate polyol having a molecular weight from 200 to 5,000, polyether polyol having a molecular weight from 200 to 5,000, or any combinations thereof, with the proviso that the isocyanate prepolymer comprises at least two free isocyanate groups. For example, the isocyanate-reactive compounds for prepared said isocyanate prepolymer can be selected from the group consisting of ethylene glycol, 1,2-propanediol, 1,3-propanediol, 1,3-butanediol, 1,4-butanediol, 1,4-butenediol, 1,4-butynediol, 1,5-pentanediol, neopentyl-glycol, bis(hydroxy-methyl) cyclohexanes such as 1,4-bis(hydroxy methyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, bishydroxyethyl-bisphenol A, bishydroxypropyl-bisphenol A, cyclohexane dimethanol, and bishydroxyethyl hydroquinone. Suitable prepolymers for use as the isocyanate compounds are prepolymers having NCO group contents of from 2 to 40 weight percent, such as from 4 to 30 weight percent. The amount of the isocyanate compound may vary based on the actual requirement of the polyurethane foam. For example, as one illustrative embodiment, the content of the isocyanate compound can be from about 5 wt % to about 60 wt %, such as from about 10 wt % to about 50 wt %, or from about 15 wt % to about 45 wt %, or from about 20 wt % to about 40 wt %, or from about 30 wt % to about 38 wt %, based on the total weight of the polyurethane composition. According to an embodiment of the present disclosure, the amount of the isocyanate compound is properly selected so that the isocyanate group is present at a stoichiometrically equivalent amount or slightly excessive amount relative to the total molar amount of the isocyanate-reactive groups (e.g. hydroxyl groups and amino groups) included in the polyol compound, the catalyst system, and any additional additives or modifiers.

According to one embodiment of the present disclosure, the polyol compound is selected from the group consisting of C₂-C₁₆ aliphatic polyhydric alcohol comprising at least two hydroxyl groups, C₆-C₁₆ cycloaliphatic polyhydric alcohol comprising at least two hydroxyl groups, C₆-C₁₆ aromatic polyhydric alcohol comprising at least two hydroxyl groups, C₇-C₁₅ araliphatic polyhydric alcohol comprising at least two hydroxyl groups, polyester polyol having a molecular weight from 500 to 12,000, polycarbonate polyol having a molecular weight from 200 to 8,000, polyether polyol having a molecular weight from 200 to 8,000, core-shell polymer polyol having a core phase and a shell phase based on polyol, or any combinations thereof. The shell phase of the core-shell polymer polyol may comprise at least one poly(C₂-C₁₀)alkylene glycol or copolymer thereof, for example, the polyol of the shell phase may be selected from the group consisting of polyethylene, (methoxy)polyethylene glycol (MPEG), polyethylene glycol (PEG), poly(propylene glycol), polytetramethylene glycol, poly(2-methyl-1,3-propane glycol) or copolymer of ethylene epoxide and propylene epoxide (polyethylene glycol-propylene glycol) with primary hydroxyl end group or secondary hydroxyl end group. The core phase of the core-shell polymer polyol may be micro-sized and may comprise any polymers compatible with the shell phase. For example, the core phase may comprise polystyrene, polyacrylnitrile, polyester, polyolefin or polyether different (in either composition or polymerization degree) from those of the shell phase. According to an embodiment of the present application, the polyol can be a composite particulate having a core-shell structure, wherein the core is a micro-sized core composed of SAN (styrene and acrylnitrile) and the shell phase is composed of PO-EO polyol. Such a polymer polyol can be prepared by radical copolymerization of styrene, acrylnitrile and poly(EO-PO) polyol comprising ethylenically unsaturated groups. According to an embodiment of the present disclosure, the polyether polyol can be prepared by polymerization of one or more linear or cyclic alkylene oxides selected from propylene oxide (PO), ethylene oxide (EO), butylene oxide, tetramethylene glycol, tetrahyfrofuran, 2-methyl-1,3-propane glycol and mixtures thereof. Exemplary polyester polyols include reaction products of polyols, preferably diols, with polycarboxylic acids or their anhydrides, such as dicarboxylic acids or dicarboxylic acid anhydrides. The polycarboxylic acids or anhydrides may be aliphatic, cycloaliphatic, aromatic and/or heterocyclic and may be substituted, e.g. with halogen atoms. The polycarboxylic acids may be unsaturated. Examples of said polycarboxylic acids include succinic acid, adipic acid, terephthalic acid, isophthalic acid, trimellitic anhydride, phthalic anhydride, maleic acid, maleic acid anhydride and fumaric acid. The polyols used in making the polyester polyols preferably have an equivalent weight of about 150 or less and include ethylene glycol, 1,2-propylene glycol, 1,3-propylene glycol, 1,4-butane diol, 1,3-butane diol, 1,6-hexane diol, 1,8-octane diol, neopentyl glycol, cyclohexane dimethanol, 2-methyl-1,3-propane diol, glycerine, trimethylolpropane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like. The amount of the polyol compound may vary based on the actual requirement of the polyurethane foam. For example, as one illustrative embodiment, the content of the polyol compound can be from about 30 wt % to about 90 wt %, such as from about 40 wt % to about 85 wt %, or from about 45 wt % to about 80 wt %, or from about 50 wt % to about 75 wt %, or from about 52 wt % to about 70 wt %, or from about 55 wt % to about 65 wt %, or from about 58 wt % to about 60 wt %, based on the total weight of the polyurethane composition.

In various embodiments of the present disclosure, the polyurethane composition comprises one or more additives selected from the group consisting of surfactant, chain extender, crosslinker, antioxidant, blowing agent, frothing agent, foam stabilizer, defoamer, tackifier, plasticizer, rheology modifier, UV-absorbent, light-stabilizer, co-catalyst, filler, colorant, pigment, water scavenger, solvent, diluent, flame retardant, slippery-resistance agent, antistatic agent, preservative, biocide and any combinations thereof. These additives can be transmitted and stored as independent components and incorporated into the polyurethane composition shortly or immediately before the combination of the isocyanate compound with the polyol. Alternatively, these additives may be contained in either of the isocyanate compound and the polyol when they are chemically inert or substantially inert to the isocyanate group or the isocyanate-reactive group.

Suitable surfactants are materials that stabilize the foam formed during the foaming reaction until the foam has sufficiently cured to be self-supportable. A wide variety of silicone surfactants commonly used in making polyurethane foams can be used in the present disclosure. Examples of such silicone surfactants are commercially available as Tegostab (Evonik Corporation), Niax (Momentive) and Dabco (Air Products and Chemicals). Surfactants are typically present in amounts up to 5 wt %, such as from 0.1 to 4 wt %, or from 0.2 to 3 wt %, or from 0.3 to 2 wt %, or from 0.4 to 1 wt %, or from 0.5 to 0.8 wt %, based on the total weight of the polyurethane composition.

One or more crosslinkers also may be present in the polyurethane composition of the present disclosure. For purposes of this invention, “crosslinkers” are materials having three or more isocyanate-reactive groups per molecule and an equivalent weight per isocyanate-reactive group of less than 300, such as less than 200. Crosslinkers usually contain from 3 to 8, especially from 3 to 4 hydroxyl (including primary hydroxyl, secondary hydroxyl and tertiary hydroxyl), primary amine, secondary amine, or tertiary amine groups per molecule and have an equivalent weight of from 30 to about 200, especially from 50 to 125. According to an embodiment of the present disclosure, the crosslinker can be selected from the group consisting of diethanol amine, triethanol amine, di-(isopropanol) amine, tri(isopropanol) amine, glycerine, trimethylol propane, pentaerythritol, and any combinations thereof; such as a combination of diethanol amine and triethanol amine. In the context of the present disclosure, the crosslinker has a molecular structure different from the amine-based catalyst.

The chain extender is a chemical having two or more isocyanate-reactive groups per molecule and an equivalent weight per isocyanate-reactive group of less than 300, such as less than 200. The isocyanate reactive groups can be hydroxyl, primary aliphatic or aromatic amino or secondary aliphatic or aromatic amino groups. Representative chain extenders include monoethylene glycol (MEG), diethylene glycol, triethylene glycol, propylene glycol, dipropylene glycol, tripropylene glycol, 1,4-butanediol, cyclohexane dimethanol, ethylene diamine, phenylene diamine, bis(3-chloro-4-aminophenyl)methane, dimethylthio-toluenediamine or diethyltoluenediamine. According to an embodiment of the present disclosure, the chain extender is a short chain (such as C₂ to C₄) polyol exclusively comprising hydroxyl group as the isocyanate-reactive group, such as monoethylene glycol. According to another embodiment of the present disclosure, the chain extender is an aliphatic or cyclo-aliphatic C₂-C₁₂ polyol having a hydroxyl functionality of 2.0 to 8.0, such as 3.0 to 7.0, or from 4.0 to 6.0, or from 5.0 to 5.5, and can be selected from the group consisting of ethylene glycol, propane diol, butane diol, pentane diol, hexane diol, 1,4-cyclohexane dimethanol, and their isomers. The chain extender can be contained as part of the component (B).

Chain extenders and crosslinkers are suitably used in small amounts, as hardness increases as the amount of either of these materials increases. The crosslinkers are typically present in amounts up to 3 wt %, such as from 0.05 to 3 wt %, or from 0.1 to 2.5 wt %, or from 0.2 to 2 wt %, or from 0.3 to 1 wt %, or from 0.4 to 0.8 wt %, or from 0.5 to 0.6 wt %, based on the total weight of the polyurethane composition. The content of the chain extender can be up to 5 wt %, such as from 0 to 3 wt %, or from 0.01 to 2.5 wt %, or from 0.05 to 2 wt %, or from 0.1 to 1 wt %, or from 0.4 to 0.8 wt %, or from 0.5 to 0.6 wt %, based on the total weight of the polyurethane composition.

One or more filler may be present in the polyurethane composition. Fillers are mainly included to reduce cost. Particulate rubbery materials are especially useful fillers. The content of the filler may constitute from 0 to 50% or more of the weight of the polyurethane composition.

The blowing agent may be a chemical (exothermic) type, a physical (endothermic type) or a mixture of at least one of each type. Chemical types typically react or decompose to produce carbon dioxide or nitrogen gas under the conditions of the foaming reaction. Water and various carbamate compounds are examples of suitable chemical blowing agents. Physical blowing agent includes carbon dioxide, various low-boiling hydrocarbons, hydrofluorocarbons, hydroflurochlorocarbons, ethers and the like. Water is one of the typical blowing agent, either by itself or in combination with one or more physical blowing agents.

According to an embodiment of the present disclosure, the polyurethane composition comprises one or more antioxidants, and exemplary antioxidants include substituted or unsubstituted phenolic antioxidants, thiocarboxylate ester antioxidants, phosphite antioxidants, phosphonite antioxidants, substituted or unsubstituted benzofuranones, substituted or unsubstituted indolinones, tocophenols, hydroxylated thiodiphenyl ethers, O-, N- and S-benzyl compounds, hydroxybenzylated malonates and triazine compounds. According to an embodiment of the present disclosure, the amount of the antioxidant is from 0 to 5 wt %, such as from 0.1 to 4 wt %, or from 0.5 to 3 wt %, or from 0.8 to 2 wt %, or from 1 to 1.5 wt %, based on the total weight of the polyurethane composition.

The process for preparing the polyurethane foam may further comprise additional additives such as foam stabilizer, defoamer, tackifier, plasticizer, rheology modifier, UV-absorbent, light-stabilizer, co-catalyst, filler, colorant, pigment, water scavenger, solvent, diluent, flame retardant, slippery-resistance agent, antistatic agent, preservative, biocide and any combinations thereof.

According to an embodiment of the present disclosure, a method of producing an polyurethane foam with reduced odor and a method for reducing/eliminating odor of polyurethane foam are provided, wherein the method comprises the steps of (i) combining at least one amine-based catalyst with at least one deodorant to form an amine-based catalyst system; and (ii) reacting at least one isocyanate compound comprising at least two isocyanate groups with at least one polyol compound in the presence of the amine-based catalyst system, or catalyzing the reaction between said isocyanate compound and polyol compound with the amine-based catalyst system, to form the polyurethane foam with reduced odor.

According to an embodiment of the present disclosure, the polyurethane foam product can be manufactured by blending the ingredients to form a reaction mixture and curing the same. Free-rise processes such as continuous slabstock production technology can be used. Alternatively, various molding methods can also be used. The processing apparatus and processing parameters for the slabstock production and molding method are generally known in the relevant field. For example, the various ingredients may be introduced individually or in various subcombinations into a mixhead or other mixing device where they are mixed and dispensed into a region (such as a trough or other open container, or a closed mold) where they are cured. It is often convenient, especially when making molded foam, to form a formulated polyol component that contains the polyol compound(s), the amine-based catalyst system, crosslinkers and/or chain extenders (if any), and any other additives such as surfactant(s) and blowing agent(s). Then this formulated polyol component contacts with the isocyanate compound (as well as any other ingredients that are not present in the formulated polyol component) to produce the foam.

Some or all of the various ingredients and/or components may be heated prior to mixing them to form the reaction mixture. In other cases, the ingredients and/or components are mixed at approximately ambient temperatures (such as from 15 to 40° C.). Heat may be applied to the reaction mixture after all ingredients have been mixed, but this is often unnecessary. Suitable conditions for promoting the curing of the polyurethane polymer include a temperature of from about 20° C. to about 150° C. In some embodiments, the curing is performed at a temperature of from about 30° C. to about 120° C. In other embodiments, the curing is performed at a temperature of from about 35° C. to about 110° C. In various embodiments, the temperature for curing may be selected at least in part based on the time duration required for the polyurethane polymer to cure at that temperature. Cure time will also depend on other factors, including, for example, the particular components (e.g., catalysts and quantities thereof), and the size and shape of the article being manufactured.

According to an embodiment of the present disclosure, the polyurethane foam product formed by the curing reaction can be flexible or rigid, and is particularly flexible polyurethane foam. The flexible polyurethane foam product may have a density of 5 to 200 kg/m³, such as from 8 to 180 kg/m³, or from 10 to 160 kg/m³, or from 12 to 150 kg/m³, or from 15 to 140 kg/m³, or from 18 to 120 kg/m³, or from 20 to 100 kg/m³, or from 24 to 80 kg/m³, or from 30 to 60 kg/m³, or from 40 to 50 kg/m³, or within a numerical range obtained by combining any two of the above stated end point values. The flexible polyurethane foam may have a resiliency of at least 50% on the ball rebound test of ASTM 3574-H.

The description hereinabove is intended to be general and is not intended to be inclusive of all possible embodiments of the invention. Similarly, the examples hereinbelow are provided to be illustrative only and are not intended to define or limit the invention in any way. Those skilled in the art will be fully aware that other embodiments, within the scope of the claims, will be apparent from consideration of the specification and/or practice of the invention as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof; and the like; and that those skilled in the art will recognize that such may be varied within the scope of the claims appended hereto.

### EXAMPLES

Some embodiments of the invention will now be described in the following Examples. However, the scope of the present disclosure is not, of course, limited to the formulations set forth in these examples. Rather, the Examples are merely inventive of the disclosure.

The information of the raw materials used in the examples is listed in the following table 1:

TABLE 1
Raw materials used in the examples

| Components | Grades | Detailed Information | Suppliers |
|---|---|---|---|
| Polyether polyol | SPECFLEX ™ | PO/EO Polyether polyol having a hydroxy | The Dow Chemical Company |
| | NC138 | functionality of 3 and a Mw of 5803 g/mol | |
| Surfactant | B8734LF2 | A polyether modified silicone (SPE) surfactant | Evonik |
| Crosslinker | DEOA | Diethanolamine | The Dow Chemical Company |
| Crosslinker | TEOA | Triethanolamine | The Dow Chemical Company |
| Amine-based Catalyst | DPA | 1,1′-((3-(dimethylamino)propyl)- | Evonik |
| | | azanediyl)-bis(propan-2-ol) | |
| | | 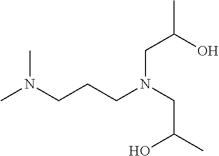 | |
| Amine-based Catalyst | DMAPA | Dimethylaminopropylamine | Evonik |
| | | 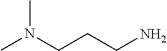 | |
| Amine-based Catalyst | Polycat 15 (PC-15) | Bis(N,N-dimethyl-3-amino-propyl)amine | Evonik |
| | | 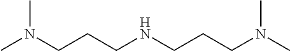 | |
| Isocyanate compound | SPECFLEX ™ | Isocyanate prepolymer made from polymeriza- | The Dow Chemical Company |
| | NE496K | tion of MDI and polyol (IP 010 Polyol) | |
| Deodorant | HBA | 4-Hydroxybutyl acrylate | The Dow Chemical Company |
| Deodorant | HEA | 2-Hydroxyethyl acrylate | The Dow Chemical Company |
| Deodorant | HEMA | 2-Hydroxyethyl methacrylate | The Dow Chemical Company |
| Deodorant | Acrylic-C12 | Dodecyl methacrylate | BASF |
| Deodorant | BGDMA | Oxybis(ethane-2,1-diyl) bis(2-methylacrylate) | BASF |
| H₂O | DI water | Deionized water | — |

### Characterization Technology

A. The DMA or TMA concentration in each sample of the comparative and inventive examples was determined with a GC-FID apparatus as shown in the following Table 2.

TABLE 2
The information about the components and process
conditions of the GC-FID apparatus

| | | |
|---|---|---|
| System | GC | Agilent 6890A GC-FID |
| | Autosampler | Agilent 7693 |
| ALS | Injection volume | 1 μL |
| Inlet | Temperature | 250° C. |
| (S/SL) | Split Ratio | 3:1; pulse split; 50 psi, 0-0.2 min |
| | Liner | Split/splitless inlet with glass wool |
| Column | Column | CP-Volamine 60 m × 0.32 mm (CP7448) |
| | Flow rate | 4 mL/min He |
| Oven | Temperature | 40° C. (8 min) at 40° C./min |
| | profile | to 250° C. (6 min) |
| FID | Temperature | 250° C. |

Each sample was prepared by dissolving 0.100 g of the catalyst or amine-based catalyst system in 1.00 mL of THF, and then 1 μL of the sample was injected into the autosampler. A serial of external standard solutions of DMA or TMA in THF were prepared and an external standard fitting plot were obtained based on the GC-FID integrated peak areas of these solutions for quantifying the DMA/TMA concentration of each comparative or inventive examples.

### Comparative Examples 1-3: The Spontaneous Generation of DMA in Amine-Based Catalyst.

In the Comparative Examples, the existence and further spontaneous formation of DMA during the aging of three commercialized typical amine-based catalysts, Polycat 15 for Comparative Example 1, DPA for Comparative Example 2 and DMAPA for Comparative Example 3, were characterized.

Samples of Polycat 15, DPA and DMAPA were commercially purchased and directly used without any pretreatment like purification. The initial DMA concentration in each sample was determined with the GC-FID.

Then each sample was aged in a sealed vial and aged in an oven kept at a constant temperature of 50° C. for two weeks, then the DMA concentration in the aged sample was further measured with the GC-FID. Without being limited by any theory, the above aging process is an accelerated imitation model of the ordinary storage/transportation of these amine-based catalysts under ambient conditions.

As shown by the experimental results in Table 3, all of the commercially purchased amine-based catalysts inevitably comprise DMA as impurities, and the concentrations of DMA significantly increased after aging. All of the catalysts exhibit unpleasant fishy odor, and the odor of the aged samples is much stronger.

TABLE 3
The DMA concentrations in the fresh catalysts and aged catalysts

| | Fresh sample | Aged sample |
|---|---|---|
| | DMA (ppm) | DMA (ppm) |
| POLYCAT 15 (PC-15) | 190.4 | 1327.3 |
| JEFFCAT DPA (DPA) | 174.1 | 826.9 |
| DMAPA | 142.2 | 621.5 |

### Inventive Examples 1 to 10 and Comparative Examples 4 to 8

In the Inventive Examples 1-10, amine-based catalyst systems were prepared by directly mixing different amounts of deodorants, as listed in Table 4, with amine-based catalysts at ambient temperature and keeping the mixture standing at ambient temperature and ambient pressure over night, wherein the unit of the deodorant content is “percentage by weight (wt %)”, based on 100 wt % of the amine-based catalyst. The DMA concentration of each sample was measured with GC-FID. The measurement results were summarized in Table 4.

TABLE 4
The formulations and DMA contents of the amine-based catalyst
systems prepared in Inventive examples (Inv. Ex) 1-10

| | Amine- | | | DMA |
|---|---|---|---|---|
| | based | | | level |
| | catalyst | Deodorant | Formulation | (ppm) |
| Inv. Ex. 1 | DPA | HBA | DPA + 1% HBA | 61.2 |
| Inv. Ex. 2 | DPA | HBA | DPA + 5% HBA | 26.1 |
| Inv. Ex. 3 | DPA | HBA | DPA + 10% HBA | Not |
| | | | | detectable |
| Inv. Ex. 4 | DPA | HEA | DPA + 1% HEA | 19.6 |
| Inv. Ex. 5 | DPA | HEA | DPA + 5% HEA | 12.2 |
| Inv. Ex. 6 | DPA | HEA | DPA + 10% HEA | 11.4 |
| Inv. Ex. 7 | PC-15 | HBA | PC-15 + 5% HBA | 61.1 |
| Inv. Ex. 8 | PC-15 | HEA | PC-15 + 5% HEA | 75.3 |
| Inv. Ex. 9 | DPA | EA(ethyl | DPA + 5% EA | 49.1 |
| | | acrylate) | | |
| Inv. Ex. 10 | DPA | GTA(Glycerol | DPA + 5% GTA | 67.1 |
| | | triacrylate) | | |

In the Comparative Examples 4-8, the procedures of the above said Inventive Examples 1-10 were repeated, except that the formulations of the amine-based catalyst systems were changed to those shown in the following Table 5.

TABLE 5
The formulations and DMA contents of the catalysts or amine-based
catalyst systems prepared in Comparative examples (Com. Ex.) 4-8

| | Amine-based | | | DMA level |
|---|---|---|---|---|
| | catalyst | Deodorant | Formulation | (ppm) |
| Com. Ex. 4 | DPA | — | DPA | 174.1 |
| Com. Ex. 5 | DPA | HEMA | DPA + 5% | 183.8 |
| | | | HEMA | |
| Com. Ex. 6 | DPA | Acrylic-C12 | DPA + 5% | 249.3 |
| | | | Acrylic-C12 | |
| Com. Ex. 7 | DPA | BGDMA | DPA + 5% | 244.5 |
| | | | BGDMA | |
| Com. Ex. 8 | PC-15 | — | PC-15 | 190.4 |

It can be seen that all the above inventive examples can effectively reduce or even completely eliminate the DMA impurities contained in the commercial amine-based catalysts, while none of the comparative examples can achieve such an effective improvement.

### Inventive Examples 11

In this Inventive Example, an amine-based catalyst system was prepared by directly mixing 99 parts by weight of DPA with 1 part by weight of HBA at ambient temperature and keeping the mixture standing at ambient temperature and pressure over night. The amine-based catalyst system was thoroughly mixed with the polyol, crosslinkers, surfactants and water as shown in the following Table 6 by a stirrer at a speed of 3000 RPM for 3 minutes to form a polyol component. The formulated polyol component was then stored at room temperature for 12-24 hour.

An aliquot of 100 g formulated polyol prepared above was mixed with 60 g of NE 496K isocyanate, reaction between the polyol and the isocyanate occurred along with notable foaming. As long as the reaction ended, the foam product sample was packaged with aluminum foil and stored at ambient environment for 7 days. 0.2 g of the foam sample was transferred into a vial having 20 mL headspace. The vial was scaled and treated at 80° C. for 2 hours, and then the gas in the headspace was sampled and measured with the GC-FID for analyzing the concentrations of DMA and TMA emitted from the polyurethane foam into the headspace.

Furthermore, a sensory evaluation was conducted by six trained panelists based on the VDA 270 method from the auto industry. The trained human panel is comprised of six in-house employees that have been certified by SGS. Co. Ltd. on odor intensity, hedonics, and odor description training. Six cubic ingots with a weight of 6 g were cut from the polyurethane foam sample prepared above. Each of the ingot was separately sealed in a 1 liter clean glass vial, and heated at 80° C. for 2 hours. Then the vial was cool down to 60° C. for sensory evaluation. Odor intensity and amine odor intensity value was evaluated and scored based on VDA 270 with below ranking criteria: (1) Not perceptible; (2) Perceptible, not disturbing; (3) Clearly perceptible, but not disturbing; (4) Disturbing; (5) Strongly disturbing; (6) Not acceptable. Averaged scores were reported as the final results.

An aliquot of 150 g polyol component prepared above was mixed with 90 g of NE 496K isocyanate under 3000 RPM for 6-8 seconds to ensure thorough mixing, and then the content was immediately poured into the popcorn barrel having a top diameter: 17 cm and a bottom diameter of 14 cm. The reaction between the polyol and the isocyanate occurred along with notable foaming. The cream time is defined as the time when the foam started to expand, and the rise time is defined as the time of complete expansion of the foaming or the time when the foam expanded to the highest height. The foam height was also recorded in centimeter (cm). The cream time, rise time and foam height were reported as measures of the catalytic reaction activity of the catalyst system.

The specific formulation and characterization results of this example are summarized in the following Table 6, wherein the contents of DMA and TMA in the headspace were represented as percentage ratio (%) as compared with the corresponding contents measured in Comparative Example 4. In particular, the DMA level in the headspace is too low to be detectable, and the TMA level in the headspace has been reduced by 54.5% (100%-45.5%).

### Inventive Examples 12

In this Inventive Example, the procedures of the Inventive Example 11 were repeated, except that the amine-based catalyst system was prepared by directly mixing 95 parts by weight of DPA with 5 parts by weight of HBA and heating the mixture at room temperature over night. The specific formulation and characterization results of this example are summarized in the following Table 6.

### Comparative Example 9

In this Comparative Example, the procedures of the Inventive Example 11 were repeated, except that fresh DPA purchased from Evonik was directly used as the catalyst with no HBA or any other deodorant added therein. The specific formulation and characterization results of this comparative example are summarized in the following Table 6.

### Comparative Example 10

In this Comparative Example, the procedures of the Comparative Example 9 were repeated, except that an aged DPA prepared in Comparative Example 2 was used as the catalyst. The specific formulation and characterization results of this comparative example are summarized in the following Table 6.

TABLE 6
The formulations and experimental results of the Comparative
Examples (Com. Ex.) 9-10 and Inventive Examples (Inv.
Ex.) 11-12, wherein all the amounts were calculated by
wt %, and LOD represents “limit of detection”.

| | | | | |
|---|---|---|---|---|
| | Com. | Com. | Inv. | Inv. |
| Components | Ex. 9 | Ex. 10 | Ex. 11 | Ex. 12 |

Foam formulations

| | | | | |
|---|---|---|---|---|
| Polyol NC138 | 92.9 | 92.9 | 92.9 | 92.9 |
| DEOA | 0.3 | 0.3 | 0.3 | 0.3 |
| TEOA | 0.6 | 0.6 | 0.6 | 0.6 |
| Catalyst DPA | 1.5 | 1.5 | 1.5 | 1.5 |
| | Fresh | Aged | Treated with | Treated with |
| | | | 1% HBA | 5% HBA |
| | | | at R.T. | at R.T. |
| B8734LF2 | 0.5 | 0.5 | 0.5 | 0.5 |
| H₂O | 4.2 | 4.2 | 4.2 | 4.2 |
| Isocyanate compound | | | | |
| NE496K | 60 | 60 | 60 | 60 |
| Effect on reactivity | | | | |
| Cream time (s) | 10 | 10 | 10 | 10 |
| Rise time (s) | 52 | 50 | 52 | 51 |
| Foam height (cm) | 24.2 | 24.3 | 24.4 | 24.1 |

Foam odor performances

| | | | | |
|---|---|---|---|---|
| In Foams | DPA | DPA | DPA treated | DPA treated |
| | fresh | aged | with 1% | with 5% |
| | | | HBA at R.T. | HBA at R.T. |
| Odor intensity (1 to 6) | 3.5 | 4.1 | 3.1 | 2.5 |
| Amine odor (1 to 6) | 2.4 | 3.1 | 1.9 | 1.3 |
| DMA level (%) | 100 | 113 | <LOD | <LOD |
| TMA level (%) | 100 | 110 | 45.5 | 36.5 |

As can be seen from the above Table 6. the polyurethane foam prepared by using the inventive catalyst system exhibit an effective elimination of DMA and a significant removal of TMA, and no substantial influence on the catalytic reactivity of the catalyst was observed.

1. A polyurethane composition for preparing a polyurethane foam, comprising
(A) at least one isocyanate compound comprising at least two isocyanate groups;
(B) at least one polyol compound; and
(C) an amine-based catalyst system, comprising
(C1) at least one amine-based catalyst selected from the group consisting of aliphatic diamine, aliphatic triamine, cycloaliphatic monoamine, cycloaliphatic diamine, cycloaliphatic triamine, araliphatic monoamine, araliphatic diamine, araliphatic triamine, aromatic monoamine, aromatic diamine, aromatic triamines, heterocyclic monoamine, heterocyclic diamine, heterocyclic triamine, and any combinations thereof; and
(C2) at least one deodorant represented by Formula (1) or Formula (2) 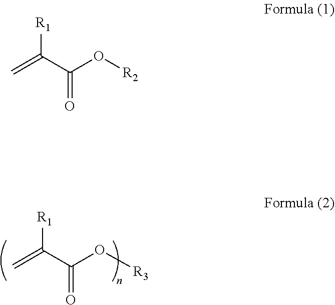
wherein R₁ is hydrogen or methyl, R₂ is selected from the group consisting of C₁-C₁₂ alkyl, hydroxy-substituted C₁-C₁₂ alkyl, and (meth)acryloxy(C₁-C₁₂ alkylene)-O—(C₁-C₁₂) alkyl, and R₃ is selected from the group consisting of divalent C₂-C₁₂ alkylene, trivalent C₃-C₁₂ alkylene and tetravalent C₄-C₁₂ alkylene, n is an integer of 2 to 4.

2. The polyurethane composition according to claim 1, wherein R₁ is hydrogen, R₂ is selected from the group consisting of C₁-C₁₂ alkyl, hydroxy-substituted C₁-C₁₂ alkyl and acryloxy (C₁-C₁₂ alkylene)-O—(C₁-C₁₂) alkyl, and R₃ is selected from the group consisting of divalent C₂-C₆ alkylene, trivalent C₃-C₆ alkylene and tetravalent C₄-C₆ alkylene.

3. The polyurethane composition according to claim 1, wherein the deodorant is selected from the group consisting of ethyl acrylate, propyl acrylate, butyl acrylate, pentyl acrylate, hexyl acrylate, 2-hydroxyethyl acrylate, 3-hydroxypropyl acrylate, 4-hydroxybutyl acrylate, 5-hydroxypentyl acrylate, 6-hydroxyhexyl acrylate, glycidyl diacrylate, ethylene diol diacrylate, propylene diol diacrylate, butylene diol diarcylate, hexane diol diacrylate, glycerol triacrylate, erythritol tetra(acrylate), pentaerythritol tetra(acrylate) and any combinations thereof.

4. The polyurethane composition according to claim 1, wherein the amine-based catalyst is selected from the group consisting of ethylene diamine, propylene diamine, butylene diamine, pentylene diamine, neopentylenediamine, hexylene diamine, heptylene diamine, neoheptylene diamine, N,N-dimethylcyclohexylamine, bis(2-dimethylaminoethyl) ether, methyltriethylenediamine, dimethylaminopropylamine, bis(N,N-dimethyl-3-amino-propyl)amine, bis(2-dimethylaminoethyl)ether, 1,1′-((3-(di-methylamino)propyl)azanediyl) bis(propan-2-ol), 2,4,6-tridimethylamino-methyl)phenol, N,N,N′, N′-tetra-methyl-ethylene diamine, N,N,N′,N′-tetramethyl-propylenediamine, N,N,N′,N′-tetramethyl-butylenediamine, N,N,N′,N′-tetramethyl-pentylenediamine, N,N,N′,N′-tetramethyl-hexylene diamine, N,N-dimethyl benzylamine, triethylenediamine, pentamethyldiethylenetriamine, diethylenetriamine, N-methylmorpholine, N-ethyl morpholine, 2-methylpropanediamine, N,N′-diethylpiperazine, N,N′-dimethyl piperazine, pyridine, N,N′-dimethyl pyridine, quinoline, N,N′,N″-tris(dimethyl amino-propyl)sym-hexahydro triazine, and any combinations thereof.

5. The polyurethane composition according to claim 1, wherein the amine-based catalyst is represented by Formula (3) 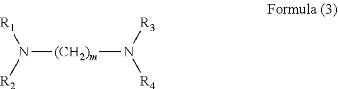
wherein m is an integer of 2 to 12, each of R₃ to R₆ is independently selected from the group consisting of H, C₁-C₁₂ alkyl, hydroxy-substituted C₁-C₁₂ alkyl, amino-substituted C₁-C₁₂ alkyl and amine-substituted C₁-C₁₂ alkyl.

6. The polyurethane composition according to claim 1, wherein the weight ratio between the deodorant and the amine-based catalyst is from 0.5:100 to 15:100.

7. The polyurethane composition according to claim 1, wherein
the isocyanate compound is selected from the group consisting of:
a) C₂-C₁₂ aliphatic isocyanate compound comprising at least two isocyanate groups, C₆-C₁₅ cycloaliphatic isocyanate compound comprising at least two isocyanate groups, C₆-C₁₅ aromatic isocyanate compound comprising at least two isocyanate groups, C₇-C₁₅ araliphatic isocyanate compound comprising at least two isocyanate groups, or a combination thereof; and
b) an isocyanate prepolymer prepared by reacting one or more isocyanate compound of a) with one or more isocyanate-reactive component selected from the group consisting of C₂-C₁₆ aliphatic polyhydric alcohol comprising at least two hydroxy groups, C₅-C₁₆ cycloaliphatic polyhydric alcohol comprising at least two hydroxy groups, C₆-C₁₆ aromatic polyhydric alcohol comprising at least two hydroxy groups, C₇-C₁₅ araliphatic polyhydric alcohol comprising at least two hydroxy groups, polyester polyol having a molecular weight from 500 to 5,000, polycarbonate polyol having a molecular weight from 200 to 5,000, polyether polyol having a molecular weight from 200 to 5,000, or any combinations thereof, with the proviso that the isocyanate prepolymer comprises at least two free isocyanate groups; and
the polyol compound is selected from the group consisting of C₂-C₁₆ aliphatic polyhydric alcohol comprising at least two hydroxyl groups, C₆-C₁₆ cycloaliphatic polyhydric alcohol comprising at least two hydroxyl groups, C₆-C₁₆ aromatic polyhydric alcohol comprising at least two hydroxyl groups, C₇-C₁₅ araliphatic polyhydric alcohol comprising at least two hydroxyl groups, polyester polyol having a molecular weight from 500 to 12,000, polycarbonate polyol having a molecular weight from 200 to 8,000, polyether polyol having a molecular weight from 200 to 8,000, core-shell polymer polyol having a core phase and a shell phase based on polyol, or any combinations thereof.

8. The polyurethane composition according to claim 1, further comprising at least one additive selected from the group consisting of surfactant, chain extender, crosslinker, antioxidant, blowing agent, frothing agent, foam stabilizer, defoamer, tackifier, plasticizer, rheology modifier, UV-absorbent, light-stabilizer, co-catalyst, filler, colorant, pigment, water scavenger, solvent, diluent, flame retardant, slippery-resistance agent, antistatic agent, preservative, biocide and any combinations thereof.

9. A polyurethane foam article, prepared by using the polyurethane composition according to claim 1.

10. A method of producing a polyurethane foam, comprising the steps of:
(i) combining at least one amine-based catalyst with at least one deodorant to form an amine-based catalyst system;
(ii) reacting at least one isocyanate compound comprising at least two isocyanate groups with at least one polyol compound in the presence of the amine-based catalyst system to produce the polyurethane foam;
wherein the amine-based catalyst is selected from the group consisting of aliphatic diamine, aliphatic triamine, cycloaliphatic monoamine, cycloaliphatic diamine, cycloaliphatic triamine, araliphatic monoamine, araliphatic diamine, araliphatic triamine, aromatic monoamine, aromatic diamine, aromatic triamines, heterocyclic monoamine, heterocyclic diamine, heterocyclic triamine, and any combinations thereof; and
the deodorant has a molecular structure represented by Formula (1) or Formula (2) 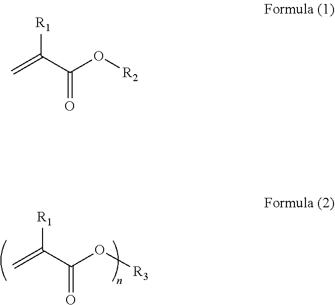
wherein R₁ is hydrogen or methyl, R₂ is selected from the group consisting of ethyl acrylate, propyl acrylate, butyl acrylate, pentyl acrylate, hexyl acrylate, C₁-C₁₂ alkyl, hydroxy-substituted C₁-C₁₂ alkyl, and (meth)acryloxy(C₁-C₁₂alkylene)-O—(C₁-C₁₂) alkyl, and R₃ is selected from the group consisting of divalent C₂-C₁₂ alkylene, trivalent C₃-C₁₂ alkylene and tetravalent C₄-C₁₂ alkylene, n is an integer of 2 to 4.
